(19) United States
(12) Patent Application Publication
(10) Pub. No.: US 2020/0081958 A1
(43) Pub. Date: Mar. 12, 2020

(54) INFORMATION PROCESSING APPARATUS, METHOD FOR DISPLAYING A WEB PAGE, AND NON-TRANSITORY RECORDING MEDIUM STORING A PROGRAM FOR DISPLAYING A WEB PAGE

(71) Applicant: GURUNAVI, INC., Tokyo (JP)

(72) Inventor: Yu KURIHARA, Tokyo (JP)

(73) Assignee: GURUNAVI, INC., Tokyo (JP)

(21) Appl. No.: 16/386,351

(22) Filed: Apr. 17, 2019

(30) Foreign Application Priority Data
Sep. 10, 2018 (JP) 2018-169186

(51) Int. Cl. G06F 17/22; H04L 29/08

(52) U.S. Cl. CPC G06F 17/2235; H04L 67/02

(57) ABSTRACT

An information processing apparatus includes: a storage that stores a web page whose location on an internet is preliminarily specified in a predetermined description format, and a web page providing circuitry that provides the web page that displays a first link that is a hyperlink to a first content that is displayed within the web page. The web page providing circuitry provides the web page that displays the first link and the first content differ from each other in display shape.

### INCORPORATION BY REFERENCE

This application is based upon and claims the benefit of priority from the corresponding Japanese Patent Application No. 2018-169186 filed on Sep. 10, 2018, the entire contents of which are incorporated herein by reference.

### BACKGROUND OF THE INVENTION

### 1. Field of the Invention

The present disclosure relates to an information processing apparatus, a method for displaying a web page, and a non-transitory recording medium storing a program for displaying a web page.

### 2. Description of Related Art

Conventionally, there is known an apparatus for displaying advertisement of a plurality of products on a web page by attaching a link(s) to a detail page providing detailed information of the products displayed on the web page, to the advertisement of the products.

In addition, there is known a display control method for, when a display is made based on screen information including a plurality of pieces of link information, displaying a plurality of pieces of information corresponding to link destinations indicated by the plurality of pieces of link information, selectively in a predetermined display region within a display region which is displayed based on the screen information.

Furthermore, there is known a method for presenting and managing advertisement which, in response to a reader's interaction to an advertisement provided on a web page, pop-up displays a web page linked to the advertisement, executes browsing operation on the pop-up displayed web page, causes the pop-up display to disappear, and transmits a browsing log to an advertisement management server.

Furthermore, there is known a web page which is displayed by a web browser and on which hyperlinks for playing moving images are displayed, and in response to a selection of a hyperlink by a user operating the web browser, another web page that plays the moving image is displayed. In addition, there is known a web page on which a still image which is small in display area and on which a hyperlink for playing a moving image is provided, and the moving image is played in a small display area while the display shape of the still image is maintained.

### SUMMARY OF THE INVENTION

An information processing apparatus relating to a first aspect of the present disclosure includes a storage that stores a web page whose location on an internet is preliminarily specified in a predetermined description format; and a web page providing circuitry that provides the web page that displays a first link that is a hyperlink to a first content that is displayed within the web page. The web page providing circuitry provides the web page that displays the first link and the first content differing from each other in display shape.

A method for displaying a web page relating to another aspect of the present disclosure includes storing a web page whose location on an internet is preliminarily specified in a predetermined description format; displaying, in the web page, a first link that is a hyperlink to a first content that is displayed within the web page; and displaying, in the web page, the first link and the first content differing from each other in display shape.

A non-transitory computer-readable recording medium storing a program for displaying a web page relating to a further aspect of the present disclosure includes storing a web page whose location on an internet is preliminarily specified in a predetermined description format, displaying, in the web page, a first link that is a hyperlink to a first content that is displayed within the web page; and displaying, in the web page, the first link and the first content differing from each other in display shape.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing an example of a software configuration of an information processing apparatus according to an embodiment;

FIG. 2 is a diagram showing a first display example of a web page provided by the information processing apparatus according to the embodiment;

FIG. 3 is a diagram showing a second display example of a web page provided by the information processing apparatus according to the embodiment;

FIG. 4 is a diagram showing a third display example of a web page provided by the information processing apparatus according to the embodiment; and

FIG. 5 is a block diagram showing an example of a hardware configuration of the information processing apparatus according to the embodiment.

### DETAILED DESCRIPTION OF EMBODIMENTS

The following describes, in detail, an information processing apparatus according to an embodiment of the present disclosure, a method for displaying a web page, and a non-transitory computer-readable recording medium storing a program for displaying a web page.

According to the conventional technologies, when a display of a content such as a moving image has the same shape as a hyperlink, the content is displayed small, thereby the browsability of the content that represents the visibility or understandability of the content may be impaired. On the other hand, an information processing apparatus, a method for displaying a web page, and a non-transitory computer-readable recording medium storing a program for displaying a web page according to the present disclosure can improve browsability of contents.

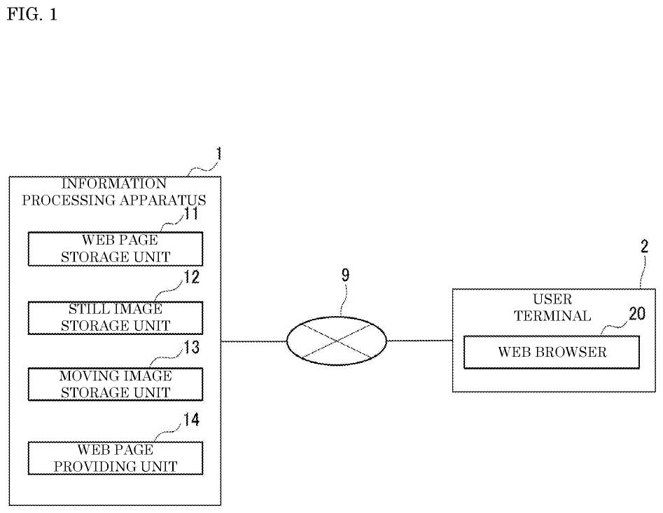

First, functions of the information processing apparatus are described with reference to FIG. 1. FIG. 1 is a block diagram showing an example of a software configuration of the information processing apparatus of the embodiment.

As shown in FIG. 1, an information processing apparatus 1 is communicably connected with a user terminal 2 via a network 9.

The information processing apparatus 1 and the user terminal 2 are each a computer or a computer system such as a smartphone, a tablet PC (personal computer), a notebook PC, a desktop PC, or a server apparatus, and are not limited to a specific hardware configuration.

The user terminal 2 is operated by a user, and includes a web browser 20. The user can browse web pages displayed by the web browser 20. The web pages refer to units of documents that are published on the web, wherein information (content) such as text or an image is displayed on the web pages. Web pages are written in a markup language such as HTML (HyperText Markup Language) or XHTML (Extensible HyperText Markup Language) and can be browsed with use of the web browser 20.

The information processing apparatus 1 includes a plurality of function units: a web page storage unit 11, a still image storage unit 12, a moving image storage unit 13, and a web page providing unit 14. Description is given on the assumption that these function units of the information processing apparatus 1 in the present embodiment are function modules implemented by an information processing program (software) according to the present embodiment. For example, the web page storage unit 11, the still image storage unit 12, and the moving image storage unit 13 may store various types of information in a nonvolatile device(s) such as a HDD (Hard Disk Drive) or a SSD (Solid State Drive). Also, the web page storage unit 11, the still image storage unit 12, and the moving image storage unit 13 may correspond to the storage of the present invention.

The web page storage unit 11 stores web pages that are written in a markup language. In the present embodiment, it is assumed that each web page includes a description(s) for providing content including at least one of a document (text), a still image, and a moving image. The web page storage unit 11 is configured to store a plurality of web pages. The plurality of web pages stored in the web page storage unit 11 may be made to form one website. The website is, for example, a collection of web pages under a specific domain name in the World Wide Web (WWW) on the Internet. That is, the web page storage unit 11 may store a website under a specific domain. In addition, the web page storage unit 11 may store a plurality of websites.

The web page storage unit 11 stores web pages whose locations on the Internet are preliminarily specified in a predetermined description format. The locations on the Internet refer to information specifying the locations on the Internet. In addition, the predetermined description format is a description format used to indicate the locations of web pages on the Internet, and is, for example, an IP (Internet Protocol) address or URI (Uniform Resource Identifier) which may include URL (Uniform Resource Locator). In the following description, “location(s) on the Internet” may be referred to as “location information”.

That the locations on the Internet can preliminarily be specified means that the location information of the web pages can preliminarily be described with the URL or the like. According to the present embodiment, the web page storage unit 11 stores web pages whose location information has preliminarily been specified. This allows the user to register the web pages as bookmarks on the browser, thereby increasing the usability of the web. It is noted that the URLs of web pages (list pages) each showing a list of search results of a search engine (search site) differ from each other depending on the search conditions, thus the location information thereof cannot be specified preliminarily. On the other hand, among the search results displayed on a list page, there may be a web page whose location information has been specified preliminarily.

The still image storage unit 12 stores contents of still images (still image contents) that are provided by the web pages stored in the web page storage unit 11. The still image contents are a part of display elements of the web pages, and display targets (still images to be displayed) and display methods are described in a markup language in the web pages. The still image storage unit 12 may temporarily store still image contents that are acquired from outside of the information processing apparatus 1. It is noted that the still image contents may include text contents.

The moving image storage unit 13 stores contents of moving images (moving image contents) that are provided by the web pages stored in the web page storage unit 11. The moving image contents are a part of display elements of the web pages, and display targets (moving images to be displayed) and display methods are described in a markup language in the web pages. The moving image storage unit 13 may temporarily store moving image contents that are acquired from outside of the information processing apparatus 1. It is noted that the moving image contents may include still image contents or text contents.

The web page providing unit 14 is, for example, a web server, and is configured to provide the user terminal 2 with the web pages stored in the web page storage unit 11. The web page providing unit 14 provides the web browser 20 of the user terminal 2 with the web pages by using HTTP (HyperText Transfer Protocol). The web page providing unit 14 may provide web pages that display a hyperlink to a content (hereinafter referred to as a “first link”) at a predetermined display position. The web pages that display the first link at a predetermined display position refer to web pages that are written in the markup language such that a display position of the first link on the web pages is preliminarily set. By displaying the first link at a predetermined display position, for example, it is possible to display the first link at a position that is easily recognized by the user visually. Also, the web page providing unit 14 may correspond to the web page providing circuitry of the present invention.

<Content Display Method>

Here, a description is given of a content display method of displaying a content (a text content, a still image content, or a moving image content) which is described in a web page provided by the web page providing unit 14. The displays of contents (a floating window display and an enlarged display) that are explained as one example in the following are executed when the user operating the web browser 20 clicks a hyperlink to a content that is contained in the web page. It is noted that a web page including a hyperlink to a content may be referred to as a “link source page”, and a web page that is displayed when the hyperlink is operated may be referred to as a “link destination page”.

The first link is, for example, a text indicating a link destination address, or, a text or a still image other than the text indicating a link destination address. In the first link, the still image other than the text indicating a link destination address is, for example, a banner including address information of the link destination. The user can display a content on a link destination page by operating a banner of a link source page displayed on the web browser 20. In addition, the still image other than the text indicating a link destination address may be a still image which is made by capturing a part of a moving image of a moving image content. Furthermore, the still image other than the text indicating a link destination address may include a still image (thumbnail image) having a low resolution of a still image content.

The first link has a predetermined display shape on the web page. The predetermined display shape is, for example, a rectangle, a circle, an oblong, or a polygon. In addition, the predetermined display shape may include a shape of a character sequence of text. The user may operate a first link of a predetermined display shape displayed on the web browser 20 (for example, operate a banner) such that a content (hereinafter referred to as a “first content”) is displayed in a display shape that is different from the display shape of the first link. By displaying the first content in a display shape that is different from the display shape of the first link, it is possible to display a content of a moving image or the like in an appropriate shape. This improves the browsability of the content. In the following display examples of contents, the display shape of the first content is different from that of the first link.

[Floating Window Display]

A floating window display is a display method of a content using a window (floating window) that is always displayed in front of the link source page. The display shape of the floating window is different from that of the first link. In the floating window display, when the user operates the first link of a predetermined display shape on a link source page, a floating window is displayed overlaid on a link source page in a display shape that different from the display shape of the first link.

The floating window may be displayed such that the display positions of the display elements contained in the link source page are not changed. The link source page includes a plurality of display elements such as the first link. However, if the display positions of all the other display elements are changed, for example, a display element related to the first content (for example, a text explaining the first content) may not be displayed. By not changing the display positions of the display elements contained in the link source page, the user can easily recognize the display position of the display element related to the first link. This further improves the browsability of the first content. The floating window is displayed overlaid on the link source page. As a result, in the floating window display, it is possible not to change the display positions of the display elements contained in the link source page.

In the floating window display, the floating window may be displayed such that it does not disappear from the display screen (it is not scrolled out) even if the link source page is scrolled. The link source page in the background of the floating window may be masked with a color gray or black. By displaying a content such that it does not disappear from the display screen, it is possible to further improve the browsability of the first content.

In the floating window display, the first content of the link destination page may be displayed in a state where the cursor position has been moved onto the first content. By displaying the first content in a state where the cursor position has been moved onto the first content, the user can easily operate the first content. This improves the operability of the first content.

In the present embodiment, the modal window display may be used instead of the floating window display. The modal window display is a method of displaying a window which does not accept an operation on the link source page until an operation on the modal window is completed. The floating window display may be implemented as the modal window display.

[Enlarged Display]

The enlarged display is a method of displaying a content in an enlarged manner in the link source page. In the enlarged display, the first content is displayed in a region having a larger display area than the display shape of the first link. For example, the first content is displayed enlarged at the display position of the first link. In the enlarged display, an enlarged first content is displayed on a part of the link source page when the user operates the first link in a predetermined display shape on the link source page.

The enlarged display may be performed such that the display position of at least a part of the display elements included in the link source page does not change. When the first content is displayed by an enlarged display, the other display elements become smaller in display area. As a result, for example, it is necessary to change the movement position by making the other display elements smaller, or by moving the display position. However, when all the display positions of the other display elements are changed, a display element related to the first content (for example, a display position at which the first link was displayed) may not be grasped. With the configuration where the display position of at least a part of the display elements included in the link source page does not change, the user can easily grasp the display position of the display element related to the first content. This further improves the browsability of the first content.

In the enlarged display, the first content of the link destination page may be displayed in a state where the cursor position has been moved onto the first content.

<Display Method of First Content>

Next, the display method of the first content on the web page provided by the web page providing unit 14 is described.

[Display of First Content Having Play Time]

A display of a first content having a play time is a display method of displaying a content having a predetermined play time. The web page providing unit 14 may provide a web page on which a first content is displayed that requires a predetermined play time. The first content that requires a predetermined play time is, for example, a moving image content. A moving image content has a predetermined play time. For a moving image content, a moving image file is downloaded or streamed when the first link is selected. The moving image content is played until a predetermined play time elapses, or until the user performs an operation to stop the playing. The user can temporarily stop, rewind, or fast-forward the moving image content while it is played. The display region (window) of the first content may be displayed until the user performs an operation of closing the region. It is noted that the first content having a play time may be, for example, a content that displays a still image for a predetermined time period.

[Continuous Display of Plurality of Contents]

The web page providing unit 14 may provide a web page that displays a plurality of first contents continuously. The continuous display of a plurality of first contents is a method of automatically displaying a first content after displaying another first content ends. The order of displaying the first contents can be set preliminarily in writing in the HTML. For example, in each of the first contents, the next first content to be displayed can be set in writing in the HTML. The first content is, for example, a moving image content.

<Second Link and Second Content>

Next, a description is given of a second link that is included in a web page provided by the web page providing unit 14. The web page providing unit 14 is configured to provide a web page that includes a second link that is a hyperlink to a second content displayed outside a web page. The second content is a web page that is different from the web page (outside the web page) provided by the web page providing unit 14. The second link is a hyperlink to a second content, and is what is called an “external link”.

As described above, the first link is a hyperlink to the first content which is displayed on the same web page as the first link (the link source page). On the other hand, the second content displayed upon operation of the second link is displayed outside the link source page. With this configuration where the first link and the second link are contained in the same page, the web page providing unit 14 allows the user to access various contents easily, wherein the first link is used to provide a content (first content) on the same web page, and the second link is used to provide a content (second content) on a different web page. This improves the browsability.

The web page providing unit 14 provides a web page in which the first link is displayed in preference to the second link. Displaying the first link in preference to the second link means that they are displayed such that the user can recognize the first link in preference to the second link. For example, in the web page, the display position of the first link may be arranged above the display position of the second link, the display size of the first link may be larger than the display size of the second link, the display color of the first link may be more conspicuous than the display color of the second link, the first link may be displayed in a navigation frame, or the display layer of the first link may be higher than the display layer of the second link. For example, when the user browses the first content before the second content, the user may understand the content more easily, and the browsability may be improved. In addition, in a case where the content of the first content is more important than the content of the second content, allowing the user to browse the first content in preference to the second content may improve the browsability. Displaying the first link in preference to the second link makes the probability of the first content being displayed higher than the probability of the second content being displayed. This improves the browsability of contents. In addition, displaying the first content preferentially by displaying the first link in preference to the second link reduces the probability that the user moves to a different web page to browse the second content and then returns to the link source page again, thereby improving the browsability of contents.

In the above description, the web page storage unit 11, the still image storage unit 12, the moving image storage unit 13, and the web page providing unit 14 are only an example of the function units included in the information processing apparatus 1, and should not limit the functions of the information processing apparatus 1. For example, the information processing apparatus 1 may not include all of the above-described function units, but may include a part thereof. In addition, the information processing apparatus 1 may include a function(s) other than the above-described functions. For example, the information processing apparatus 1 may include an input function for inputting information, or an output function for notifying the apparatus operation state by an LED lamp or the like.

According to the above-described description, the function units of the information processing apparatus 1 are implemented by software. However, at least one or more of the function units of the information processing apparatus 1 may be implemented by hardware.

In addition, with regard to the above-described function units of the information processing apparatus 1, one function unit may be divided into a plurality of function units when implemented. Furthermore, two or more of the above-described function units of the information processing apparatus 1 may be integrated into one function unit when implemented. FIG. 1 represents the functions of the information processing apparatus 1 by function blocks, and it does not suggest that the function units are individual program files or the like.

The information processing apparatus 1 may be an apparatus that is realized in one housing, or may be a system realized by a plurality of apparatuses that are connected to each other via a network or the like. For example, the information processing apparatus 1 may be realized as a virtual apparatus such as a cloud service that provides a part or all of the functions of the information processing apparatus 1 by a cloud computing system. That is, at least one or more function units among the above-described function units of the information processing apparatus 1 may be realized by other apparatus(es). Furthermore, the information processing apparatus 1 may be a general-purpose computer such as a desktop personal computer, or may be a dedicated apparatus having limited functions.

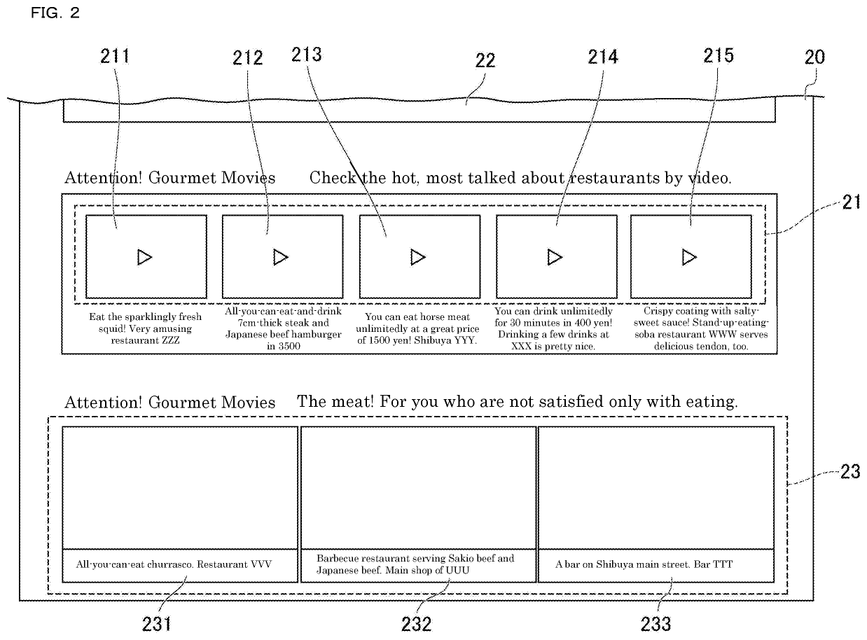

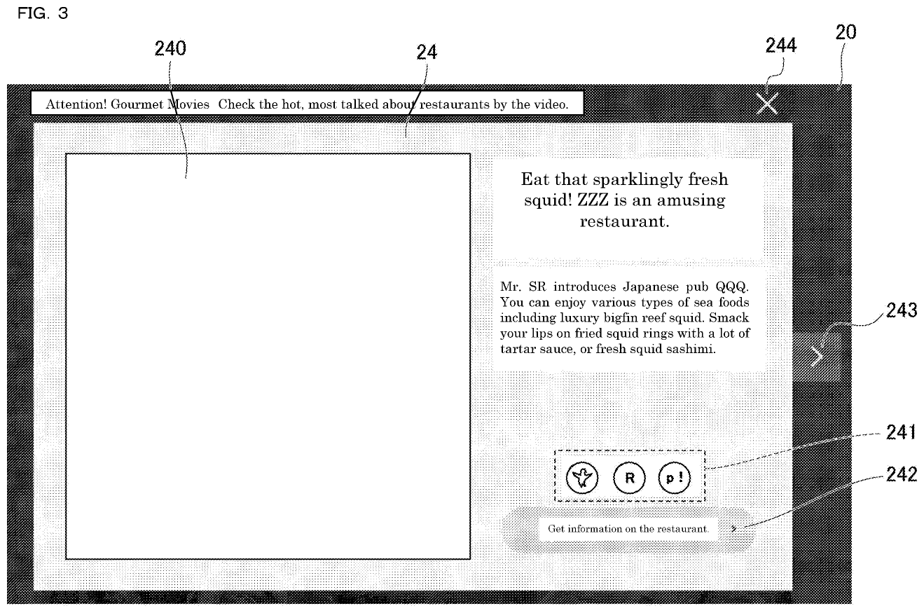

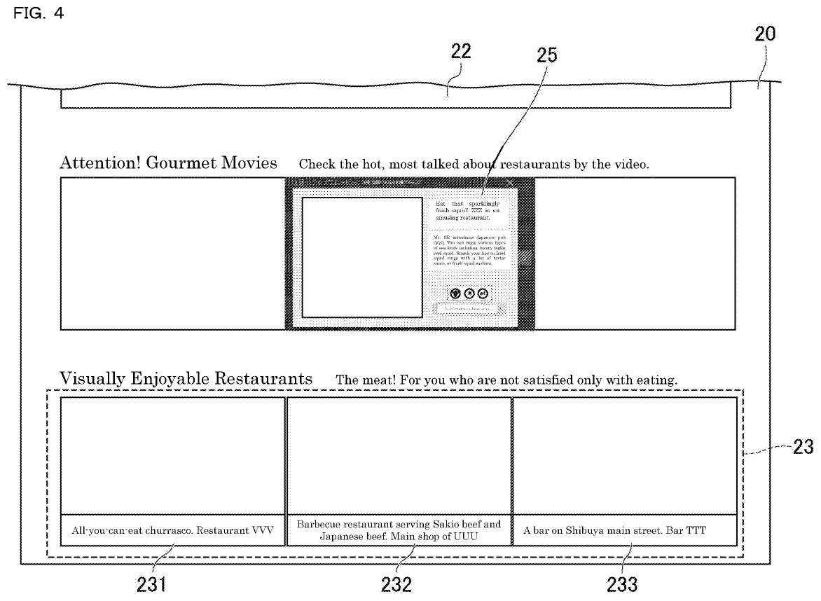

Next, web pages provided by the web page providing unit 14 are described with reference to FIG. 2 to FIG. 4. FIG. 2 to FIG. 4 show display examples of web pages provided by the web page providing unit 14, displayed on the web browser 20 of the user terminal 2. FIG. 2 shows a first display example of a web page provided by the information processing apparatus 1 according to the present embodiment. FIG. 3 shows a second display example of a web page provided by the information processing apparatus 1 according to the present embodiment. FIG. 4 shows a third display example of a web page provided by the information processing apparatus 1 according to the present embodiment.

FIG. 2 shows a display example of a link source page. In FIG. 2, the web browser 20 is displaying a web page that includes a first link 21, a still image 22, and a second link 23. The first link 21 includes a first link 211, a first link 212, a first link 213, a first link 214, and a first link 215. The second link 23 includes a second link 231, a second link 232, and a second link 233.

In the web page, the first link 21 is arranged above the second link 23. That is, the first link 21 is displayed in preference to the second link 23. This allows the user to visually recognize the first link 21 in preference to the second link 23, increasing the probability of the first link being operated in preference to the second link.

The first links 211 to 215 are hyperlinks for playing moving image contents that are first contents. When the user operates one of the first links 211 to 215 that are hyperlinks, a moving image content is played as a first content corresponding to the operated first link. On each of the first links 211 to 215, a still image that is a part of the corresponding moving image content captured therefrom, and a triangular icon representing “play” are displayed. The first links 211 to 215 are hyperlinks to moving image contents that introduce restaurants.

The still image 22 is a still image content displayed on the web page. The second links 231 to 233 are hyperlinks for displaying second contents that are provided in other web pages. When the user operates one of the second links 231 to 233 that are hyperlinks, a content that is a second content corresponding to the operated second link, is displayed in another web page. For example, the second links 231 to 233 are hyperlinks for displaying web sites that are individually provided by restaurants.

FIG. 3 shows a floating window that is displayed as a first content when the first link 211 is operated. In FIG. 3, the web browser 20 is displaying a link destination page including a floating window 24. The floating window 24 includes a moving image playing unit 240, a second link 241, a second link 242, a switch button 243, and a close button 244. The floating window 24 is displayed overlaid on the link source page shown in FIG. 2. FIG. 3 indicates that the floating window 24 is masking the link source page.

The moving image playing unit 240 is a display unit for playing and displaying a moving image content. The user can play, stop, rewind, or fast-forward the moving image content on the moving image playing unit 240.

When playing a moving image on the moving image playing unit 240 ends or when the user operates the switch button 243, the floating window 24 displays the next content (for example, a moving image content corresponding to the first link 212) in continuation.

The second link 241 includes a button that is operated for the floating window 24 to be shared by the SNS (Social Network Service). When the user operates any one of the buttons provided on the second link 241, the URL of the floating window 24 is shared by the SNS.

The second link 242 is a hyperlink for displaying a web site of a restaurant introduced on the floating window 24.

The close button 244 is for closing the floating window 24. When the close button 244 is operated, the floating window 24 is closed and the link source page is displayed again.

It is noted that the floating window 24 is displayed from the first link 211. As a result, the floating window 24 is a web page that belongs to a layer lower than the link source page. Accordingly, the second links 241 and 242 are displayed in a layer lower than the first link 211. That is, the first link 211 is displayed in preference to the second links 241 and 242.

FIG. 4 shows an enlarged display as a first content that is displayed when the first link 211 is operated. In FIG. 4, the web browser 20 displays a web page that includes an enlarged display 25, the still image 22, and the second link 23. The still image 22 and the second link 23 are the same as those shown in FIG. 2, and description thereof is omitted.

The enlarged display 25 is an enlarged display overlaid on the first link 21 shown in FIG. 2. The functions included in the enlarged display 25 are the same as those of the floating window 24. That is, the enlarged display 25 includes the functions of the moving image playing unit 240, the second link 241, the second link 242, the switch button 243, and the close button 244.

Meanwhile, in the link source page shown in FIG. 2, the first link 21 is linked to contents for “Attention! Gourmet Movies”, and the second link 23 is linked to contents for “Visually Enjoyable Restaurants”. Here, the contents for “Attention! Gourmet Movies” are arranged between the still image 22 and the contents for “Visually Enjoyable Restaurants”. The arrangement allows the user to browse the web page in the display order of contents. That is, the user can recognize, at the scroll position on the web page, which content(s) has been browsed, and which content(s) has not been browsed.

When the first link 211 is operated and the enlarged display 25 is displayed, the display positions of the still image 22 and the second link 23 are not changed. This allows the user to recognize the scroll position of the enlarged display 25 on the web page such that the user can browse the second link 23 that has not been browsed when browsing of the first link 21 is completed.

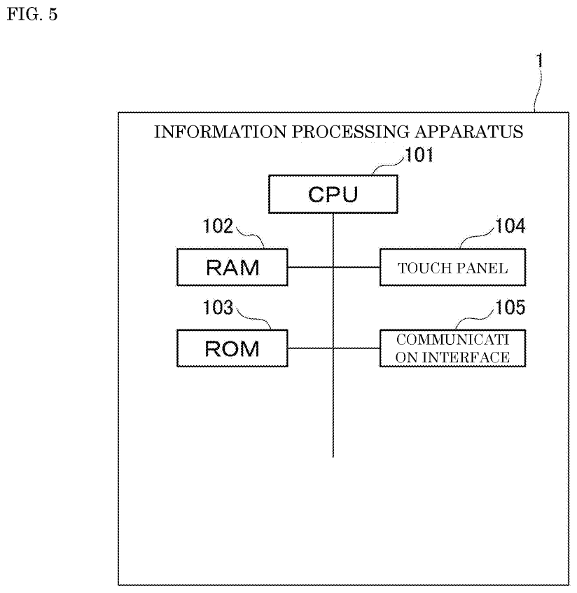

Next, the hardware configuration of the information processing apparatus 1 is described with reference to FIG. 5. FIG. 5 is a block diagram showing an example of the hardware configuration of the information processing apparatus 1 according to the present embodiment.

The information processing apparatus 1 includes a CPU (Central Processing Unit) 101, a RAM (Random Access Memory) 102, a ROM (Read Only Memory) 103, a touch panel 104, and a communication interface 105. The information processing apparatus 1 is configured to execute the information processing program described with reference to FIG. 1.

The CPU 101 controls the user terminal by executing the information processing program stored in the RAM 102 or the ROM 103. The information processing program is acquired from a recording medium in which the program is recorded, or from, for example, a program distribution server via a network, and the acquired information processing program is installed in the ROM 103, and is read therefrom to be executed.

The touch panel 104 has an operation input function and a display function (operation/display function). The touch panel 104 allows the user of the information processing apparatus 1 to perform operation input using a finger tip, a touch pen or the like. In the present embodiment, the information processing apparatus 1 includes the touch panel 104 that has the operation/display function. However, the information processing apparatus 1 may include a display device and an operation input device individually, wherein the display device has a display function and the operation input device has an operation input function. In that case, the display screen of the touch panel 104 can be implemented as the display screen of the display device, and the operation of the touch panel 104 can be implemented as the operation of the operation input device. It is noted that the touch panel 104 may take various forms such as a display of a head mount type, a glasses type, or a wrist watch type.

The communication interface 105 is an interface for performing communications. The communication interface 105 executes, for example, executes a wireless LAN, a wired LAN, or a short-range radio communication of infrared type or the like. In FIG. 5, only the communication interface 105 is shown as an interface for communication. However, the information processing apparatus 1 may include a communication interface for each of a plurality of communication methods.

The above-described various processes of the present embodiment may be executed by recording a program for realizing the functions of the devices described in the present embodiment, in a computer-readable recording medium, causing a computer system to read the program from the recording medium, and causing the computer system to execute the program. Here, the “computer system” may include an OS and hardware such as peripheral equipment. In addition, in a case where a WWW system is used, the “computer system” may include homepage providing environment (or homepage displaying environment). In addition, the “computer-readable recording medium” refers to a writable nonvolatile memory such as a flexible disk, a magneto-optical disk, a ROM, or a flash memory, a portable medium such as a CD-ROM, or a storage device such as a hard disk embedded in a computer system.

Furthermore, the “computer-readable recording medium” includes a medium holding the program for a predetermined time period, such as a volatile memory inside the computer system (for example, a DRAM (Dynamic Random Access Memory)) that becomes a server or a client when the program is transmitted via a network such as the Internet, or a communication line such as a telephone line. In addition, the program may be transmitted from a computer system whose storage device or the like stores the program, to another computer system via a transmission medium or by a transmission wave in the transmission medium. Here, the “transmission medium” for transmitting the program refers to a medium having a function to transmit information, such as a network (communication network) such as the Internet, or a communication line (communication wire) such as a telephone line. In addition, the program may realize only a part of the above-described functions. Furthermore, the program may be what is called a difference file (difference program) that is used in combination with a program that has already been recorded in the computer system, to realize the above-described functions.

According to an embodiment of the present disclosure, an information processing apparatus, a method for displaying web page, and a non-transitory recording medium storing a program for displaying a web page improve browsability of contents by including a first link that is a hyperlink to a first content that is displayed within a web page whose location on an internet is preliminarily specified in a predetermined description format, the first link and the first content differing from each other in display shape.

In addition, in the information processing apparatus of the embodiment, the web page displays the first content via the first link so that a display position of at least a part of display elements displayed on the web page is not changed. In addition, the web page displays, as the first content, a content having a predetermined play time. In addition, the web page displays, as the first content, a plurality of contents continuously. In addition, the web page displays the first link at a predetermined display position. In addition, the web page further includes a second link that is a hyperlink to a second content that is displayed outside the web page. In addition, the web page displays the first link in preference to the second link.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. An information processing apparatus comprising:
a storage that stores a web page whose location on an internet is preliminarily specified in a predetermined description format; and
a web page providing circuitry that provides the web page that displays a first link that is a hyperlink to a first content that is displayed within the web page,
wherein the web page providing circuitry provides the web page that displays the first link and the first content differing from each other in display shape.

2. The information processing apparatus according to claim 1, wherein
the web page providing circuitry provides the web page that displays the first content via the first link so that a display position of at least a part of display elements displayed on the web page is not changed.

3. The information processing apparatus according to claim 1, wherein
the web page providing circuitry provides the web page that displays, as the first content, a content having a predetermined play time.

4. The information processing apparatus according to claim 1, wherein
the web page providing circuitry provides the web page that displays, as the first content, a plurality of contents continuously.

5. The information processing apparatus according to claim 1, wherein
the web page providing circuitry provides the web page that displays the first link at a predetermined display position.

6. The information processing apparatus according to claim 1, wherein
the web page providing circuitry provides the web page that displays a second link that is a hyperlink to a second content that is displayed outside the web page.

7. The information processing apparatus according to claim 6, wherein
the web page providing circuitry provides the web page that displays the first link in preference to the second link.

8. A method for displaying a web page comprising:
storing a web page whose location on an internet is preliminarily specified in a predetermined description format;
displaying, in the web page, a first link that is a hyperlink to a first content that is displayed within the web page; and
displaying, in the web page, the first link and the first content differing from each other in display shape.

9. A non-transitory computer-readable recording medium storing a program for displaying a web page comprising:
storing a web page whose location on an internet is preliminarily specified in a predetermined description format;
displaying, in the web page, a first link that is a hyperlink to a first content that is displayed within the web page; and
displaying, in the web page, the first link and the first content differing from each other in display shape.
